(19) United States
(12) Patent Application Publication
(10) Pub. No.: US 2014/0209463 A1
(43) Pub. Date: Jul. 31, 2014

(54) TRAVELING WAVE DIELECTROPHORESIS SENSING DEVICE

(71) Applicant: HEWLETT-PACKARD DEVELOPMENT COMPANY, L.P., Fort Collins, CO (US)

(72) Inventors: Gary Gibson, Palo Alto, CA (US); Alexandre M. Bratkovski, Mountain View, CA (US); Zhiyong Li, Foster City, CA (US); Steven J. Barcelo, Palo Alto, CA (US); Zhang-Lin Zhou, Palo Alto, CA (US)

(73) Assignee: Hewlett-Packard Development Company, L.P., Fort Collins, CO (US)

(21) Appl. No.: 13/753,796

(22) Filed: Jan. 30, 2013

(51) Int. Cl. G01N 21/47

(52) U.S. Cl. CPC G01N 21/47; B82Y 25/00
USPC 204/547; 204/643; 977/902; 977/838

(57) ABSTRACT

The present disclosure is drawn to traveling wave dielectrophoresis sensing devices and associated methods. In an example, a traveling wave dielectrophoresis sensing device can comprise an array of electromagnetic field enhancing nanostructures attached to the substrate, the electromagnetic field enhancing nanostructures including a metal; a plurality of conductive element electrically associated with the electromagnetic field enhancing nanostructures; and a controller for applying alternating and out of phase potential to the plurality of conductive elements to form traveling wave dielectrophoretic forces within the array.

### BACKGROUND

Systems for performing molecular analysis can include the use of surface-enhanced Raman spectroscopy (SERS), enhanced fluorescence, enhanced luminescence, and plasmonic sensing, among others. With specific regard to SERS, Raman spectroscopy is a spectroscopic technique used in condensed matter physics and chemistry to study various low-frequency excitation modes in molecular systems. In further detail, an approximately monochromatic beam of light of a particular wavelength range passes through a sample of molecules and a spectrum of scattered light is emitted. The spectrum of wavelengths emitted from the molecule is called a “Raman spectrum” and the emitted light is called “Raman scattered light.” A Raman spectrum can reveal electronic, vibrational, and rotational energy levels of a molecule. Different molecules produce different Raman spectra that can be used like a fingerprint to identify molecules and even determine the structure of molecules. With this and other sensing techniques, enhancing device sensitivity, providing additional flexibility, etc., in such devices would be desirable.

### BRIEF DESCRIPTION OF THE DRAWINGS

Additional features and advantages of the invention will be apparent from the detailed description which follows, taken in conjunction with the accompanying drawings, which together illustrate, by way of example, features of the disclosure.

FIG. 1 is a cross-sectional view of a traveling wave dielectrophoresis device in accordance with an example of the present disclosure;

FIG. 2 is an up-close cross-sectional view of a traveling wave dielectrophoresis device in accordance with an example of the present disclosure;

FIG. 3 is a perspective view of a traveling wave dielectrophoresis device in accordance with an example of the present disclosure; and

FIG. 4 is a cross-sectional view of a traveling wave dielectrophoresis device in accordance with an example of the present disclosure;

FIG. 5 is a cross-sectional view of an alternative traveling wave dielectrophoresis device in accordance with an example of the present disclosure;

FIG. 6 is a cross-sectional view of another traveling wave dielectrophoresis device in accordance with an example of the present disclosure;

FIG. 7 is a cross-sectional view of another traveling wave dielectrophoresis device in accordance with an example of the present disclosure;

FIG. 8 is a graph depicting a Clausius-Mossotti function K(ω₁) as function of ω₁;

FIG. 9 is a flow chart of a method in accordance with an example of the present disclosure; and

FIG. 10 is a flow chart of another method in accordance with an example of the present disclosure.

Reference will now be made to various examples illustrated herein, and specific language will be used herein to describe the same. It will nevertheless be understood that no limitation of the scope of the disclosure is thereby intended.

### DETAILED DESCRIPTION

Raman spectroscopy can be used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which are ordinarily in the optical frequency domain. The excited molecule then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different molecules or matter has characteristic peaks that can be used to identify the species. As such, Raman spectroscopy is a useful technique for a variety of chemical or biological sensing applications. However, the intrinsic Raman scattering process can be inefficient. That being stated, this process can be made significantly more efficient through the use of structures that create local electromagnetic “hot spots” where fields due to the incident excitation light are greatly enhanced via plasmonic effects (collective electron density excitations). However, the enhancement in the Raman signal due to such SERS processes is still inadequate in some cases, partly because most SERS systems only enhance the electro-magnetic field at the hot spots, which typically only occupy a small fraction of the sample volume. In many cases, analytes are spread relatively evenly across the entire SERS substrate, such as by simple diffusion followed by adsorption. If the signal or detection of such analytes could be further enhanced, surface enhanced Raman spectroscopy would be useful in a wider range of applications. As mentioned, in more traditional SERS systems, random diffusion of analyte species into the hot spots is typically relied upon, and at low analyte concentrations, the occupation of hot spots by analyte molecules may likewise be low. Furthermore, in many cases non-analyte species present in the sample may enter the hot spots and result in competing Raman signals.

To further complicate the issue, it may be sometimes desirable to separate multiple analyte species and direct them to different areas of a SERS-active surface for analysis, or separate analytes from contaminants that produce competing signals. Accomplishing this would be particularly desirable if different regions of the test apparatus could be designed for different analytes by employing SERS-active structures that are i) optimized for those analytes, ii) functionalized to bind certain analytes, iii) interrogated by excitation sources optimized for particular analytes, and/or iv) utilize detectors tuned for different Raman spectra, for example.

Thus, it has been recognized that it would be advantageous to develop a traveling wave dielectrophoresis system based on a new class of surface-enhanced Raman spectroscopy (SERS) structures, and particularly, control and generate hot spots of such structures using traveling wave dielectrophoresis. Thus, dielectrophoretic (DEP) forces can be used to control the motion of analytes relative to SERS-active structures, as well as to control the configuration of the structures themselves, i.e. actually generating hot spots. These DEP forces include those arising from both the real and imaginary parts of the Clausius-Mossotti factor, the latter of which results in what is known as traveling-wave DEP (or AC dielectrophoresis), and can be supplemented by electrophoretic forces if the species (particle or structure) to be moved is charged. More specifically, DEP can be used to apply forces of different magnitude and/or direction to species of molecules or analytes with different Clausius-Mossotti factors, and for analytes that cannot be driven directly via DEP, i.e. species that do not have appropriate Clausius-Mossotti factors or functions, by particles that can be engineered to provide desired Clausius-Mossotti functions. These particles can be functionalized to capture analytes of interest so that their motion can be independently controlled via DEP and/or electrophoretic forces. Furthermore, combinations of dielectrophoretic and electrophoretic forces can be used to control the gaps between structures on flexible elements that form Raman hot-spots, such as plasmonic particle-on-post SERS surfaces.

With this background in mind, it is noted that when discussing a traveling wave dielectrophoresis sensing device or related method, each of these discussions can be considered applicable to the other embodiment, whether or not they are explicitly discussed in the context of that embodiment. Thus, for example, in discussing conductive elements used with the traveling wave dielectrophoresis sensing device, such a structure can also be used in the methods, and vice versa.

A traveling wave dielectrophoresis sensing device can include a substrate and an array of electromagnetic field enhancing nanostructures attached to the substrate. The electromagnetic field enhancing nanostructures can include a metal, e.g., metal, metal alloy, metal composite, dielectric and metal combination, etc. The sensing device can further include a plurality of conductive element electrically associated with the electromagnetic field enhancing nanostructures, and a controller for applying alternating and out of phase potential to the plurality of conductive elements to form traveling wave dielectrophoretic forces within the array. In certain examples, the electromagnetic field enhancing nanostructures can be deposited and affixed directly to the substrate, or alternatively, the electromagnetic field enhancing nanostructures can be applied to elongated nanostructures.

In various embodiments, the traveling wave dielectrophoretic force can be a lateral force which can be introduced within the array for any of a number of different purposes. For example, the controller can be adapted to create the traveling wave dielectrophoretic lateral force for generating a hot spot within the array. The hot spot can be formed by movement of a mobile engineered particle or plasmon-supporting particle to a closer proximity with respect to an electromagnetic field enhancing nanostructure, which may be attached directly to a substrate or attached to a substrate through an elongated nanostructure, such as at the tip or elsewhere with respect to an elongated nanostructure. In one specific example, the driven particle can be a mobile engineered particle including a dielectric core and a metal shell. The metal shell can be further modified or functionalized by surface active ligands that may be used to attach analytes, as will be discussed further hereinafter. In another example, the hot spot can be generated by movement of one or both of two adjacent elongated nanostructures toward one another (or one toward another). In this example, the electromagnetic field enhancing nanostructure is typically located at or near a tip of a flexible elongated nanostructure. In other examples, the controller can be adapted to create the traveling wave dielectrophoretic lateral or other force for movement of analytes toward a hot spot. Thus, hot spots can be created using the traveling wave dielectrophoretic force, and/or analytes can be moved toward or away from hot spots that already exist or are formed by the traveling wave dielectrophoretic lateral force.

As used herein, the term “nanostructure” refers to any structure having dimensions of width or diameter less than 1 micron. An “elongated nanostructure” is defined further to include structures that have an aspect ratio with a length at least two times longer than the shortest width. More specifically, elongated nanostructures may have an aspect ratio from 2:1 to 20:1, or from 3:1 to 10:1, with the aspect ratio being based on the longest dimension to the shortest dimension. Examples can include nanocones, nanopyramids, nanorods, nanobars, nanofingers, nanopoles and nanograss, without limitation thereto. As used herein, the terms “nanocones,” “nanopyramids,” “nanorods,” “nanobars,” “nanopoles” and “nanograss,” refer to structures that are substantially: conical, pyramidal, rod-like, bar-like, pole-like and grass-like, respectively, which have nano-dimensions as small as a few tens of nanometers (nm) in height and a few nanometers in diameter, or width. For example, flexible columns may include nano-columns having the following dimensions: a diameter of 10 nm to 500 nm, a height of 20 nm to 2 micrometers (μm), and a gap between flexible columns of 20 nm to 500 nm. The terms of art, “substantially conical,” “substantially pyramidal,” “substantially rod-like,” “substantially bar-like,” “substantially pole-like” and “substantially grass-like,” describe various structures that can be used, and include structures that have nearly the respective shapes of cones, pyramids, rods, bars, poles and grass-like asperities within the limits of fabrication with nanotechnology.

As used herein, when referring to an “electromagnetic field enhancing nanostructure” that includes a “metal” attached to a substrate or attached to an elongated nanostructure (which is attached to the substrate), this refer to nanoparticles, nanospheres, prolate nanoellipsoids, oblate nanoellipsoids, nanodisks, and nanoplates, having a width or diameter of 500 nm or less. As used herein, the terms “nanospheres,” “prolate nanoellipsoids,” “oblate nanoellipsoids,” “nanodisks,” and “nanoplates,” refer to structures that are substantially: spherical, prolate ellipsoidal, oblate ellipsoidal, disk-like, and plate-like, respectively, which have nano-dimensions as small as a few nanometers in size: height, diameter, or width. In addition, the terms “substantially spherical,” “substantially prolate ellipsoidal,” “substantially oblate ellipsoidal,” “substantially disk-like,” and “substantially and plate-like,” describe structures that have nearly the respective shapes of spheres, prolate ellipsoids, oblate ellipsoids, disks, and plates within the limits of fabrication with nanotechnology.

Generally, in examples where an elongated nanostructure is present, In one example, this structure can include a non-metallic column with a metallic coating or metallic cap. However, other structures, other than columns can be used, as described above with respect to the term “elongated nanostructures.” The nanostructure can include a polymer, such as a resist, coated with a SERS-active metal as the electromagnetic field enhancing nanostructure, e.g. gold, silver, copper, platinum, aluminum, etc., or a combination of these metals in the form of alloys. Likewise, the SERS-active metal can be part of a layered structure including layers of different materials, including a metal layer. Generally, the SERS-active metal can be selectively coated on the tips of the non-metallic column or deposited thereon. In addition, the SERS-active metal can be a multilayer structure, for example, 10 to 100 nm silver layer with 1 to 50 nm gold over-coating, or vice versa. Additionally, the SERS-active metal can be further coated with a thin dielectric layer.

In one example, where appropriate, the use of a polymer or other compliant material can render the nanostructures sufficiently flexible to permit bending so that the tips can meet at the top of the structures or be brought into close proximity. Examples of suitable polymers that can be used include, but are not limited to, polymethyl methacrylate (PMMA), polycarbonate, siloxane, polydimethylsiloxane (PDMS), photoresist, nanoimprint resist, and other thermoplastic polymers and UV curable materials including one or more monomers/oligomers/polymers. In another example, the nanostructures can include an inorganic material having sufficient flexibility to bend where bending is desired. Examples of such inorganic materials include silicon oxide, silicon, silicon nitride, alumina, diamond, diamond-like carbon, aluminum, copper, and the like.

The traveling wave dielectrophoresis sensing device can further include a detector operatively coupled to the array which includes the electromagnetic field enhancing nanostructures attached to the substrate (either directly, or though another nanostructure). In one example, the detector can be a colorimeter, a reflectometer, a spectrometer, a spectrophotometer, a Raman spectrometer, an optical microscope, and/or an instrument for measuring luminescence. Also, in accordance with example of the present disclosure, a controller can be present that controls the electrical potentials used to generate traveling wave dielectrophoretic forces, as will be described in greater detail hereinafter.

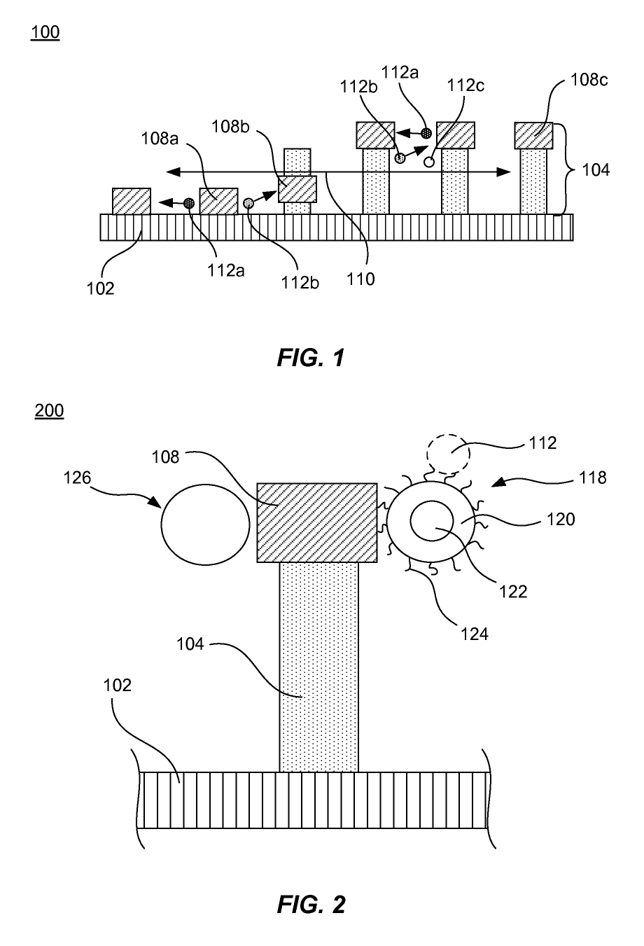

Referring now to FIG. 1, a traveling wave dielectrophoresis sensing device 100 can include a substrate 102 having electromagnetic field enhancing nanostructures 108a, 108b, 108c attached thereto. In one example, the electromagnetic field enhancing nanostructures 108a are attached directly to the substrate. In other examples, the electromagnetic field enhancing nanostructures 108b, 108c are integrated with elongated nanostructures 104 that are attached to the substrate. The electromagnetic field enhancing nanostructures can be attached as a tip of the elongated nanostructure as shown at 108c, or elsewhere on the elongated nanostructure as shown at 108b. While the present figure provides a specific structure of the traveling wave dielectrophoresis sensing device, it is understood that the illustrated structure is not intended to be limiting and that the present disclosure contemplates the use of various elements as discussed herein. For example, the electromagnetic field enhancing nanostructures 108c that are shown as metallic caps could also be a metallic coating. Likewise, the elongated nanostructures which are shown as columns could likewise be an alternative elongated nanostructure.

In further detail, traveling wave dielectrophoresis can be used to independently control the motion of particles with different Clausius-Mossotti factors by controlling the frequency and phase of the electrical sources used to provide electrical potentials to the array. The frequency dependence of the Clausius-Mossotti factors can be used to provide traveling wave dielectrophoretic forces 110, which in the example shown, may be lateral forces. These forces can have a different impact on different particle or analyte species. For example, some particles or analytes may move in one direction as shown at 112a, while other particles or analytes may move in another direction, as shown at 112b. Still other particles or analytes may be unaffected by the traveling wave dielectrophoretic force as shown at 112c. By utilizing both the real and imaginary parts of the Clausius-Mossotti factors, along with appropriate electrode designs, independent control of their motion in three dimensions can be achieved on various analytes or mobile engineered particles that become bound to certain analytes. Thus, in some examples, desired analyte species can be driven into particular Raman hot spots of SERS structures.

Referring to FIG. 2, a closer view of a traveling wave dielectrophoresis device 200 is shown. It is noted that the elements of FIG. 2, or any of the FIGS. herein, are not necessarily drawn to scale, nor does it represent every traveling wave dielectrophoresis device available for use herein, i.e. it provides merely an exemplary embodiment of one traveling wave dielectrophoresis device. In this example, the device includes an elongated nanostructure including a substrate 102 attached to a elongated nanostructure 104 with a metallic cap 108 deposited thereon. A mobile engineered particle 118 having three layers is shown. Specifically, the mobile engineered particle includes a metal shell 120 with a dielectric core 122. The mobile engineered particle can likewise be reversed with a metal core and a dielectric shell. In the example shown, however, the metal shell is further functionalized with a ligand 124 that can bind preferentially to an analyte 112. Thus, when a hot spot is created, traveling wave dielectrophoresis lateral or other forces can be used to drive the mobile engineered particle toward the hot spot. As the ligand attached to the surface of the mobile engineered particle is bound to the analyte, the analyte is brought along with the mobile engineered particle to the hot spot. This arrangement is useful when the analyte of interest does not inherently exhibit Clausius-Mossotti factors that are impacted by the lateral or other forces provided by traveling wave dielectrophoresis in a desired fashion, e.g., analyte 112c in FIG. 1, or analytes that could not otherwise be separated from other species. It is also notable, however, that the mobile engineered particle can be used to both generate the hot spot, as well as bring the analyte therewith to the hot spot that the mobile engineered particle is being used to generate. Thus, in further detail, some analytes can be dielectrophoretically driven directly (if they have appropriate Clausius-Mossotti factors). Others can be attached to nanoparticles that have been functionalized to bind to them. The nanoparticles can metallic particles or core-shell particles engineered to have a desired Clausius-Mossotti function. These nanoparticles can also include materials (e.g. noble metals) that help to create hot spots when the particles are moved proximate to the nanostructures.

Alternatively, mobile engineered particles may also be used merely to generate hot spots, and not to move analytes at all. To illustrate, mobile engineered particle 126, which may include a metal particle, a core shell metal particle, or any other type of mobile engineered particle suitable for forming hot spots in the systems of the present disclosure, can be used merely to generate hot spots within the array. These particles might not be surface functionalized, as they are not intended to move analytes as with mobile engineered particle 118. In one specific example, plasmonic particles (e.g. Au) can be used. In this and other similar examples, traveling wave dielectrophoresis can be used to generate traveling wave dielectrophoretic lateral forces within the array of nanostructures causing the mobile engineered particles to move toward the metallic cap 108. Once in this configuration, hot spots can be generated that are useful for various purposes, such as increasing the number of hot spots in an array, thereby potentially increasing the number of analyte molecules that can be measured at or near the increased number of hot spots, or increasing the number of hot spots in a desired region of the array.

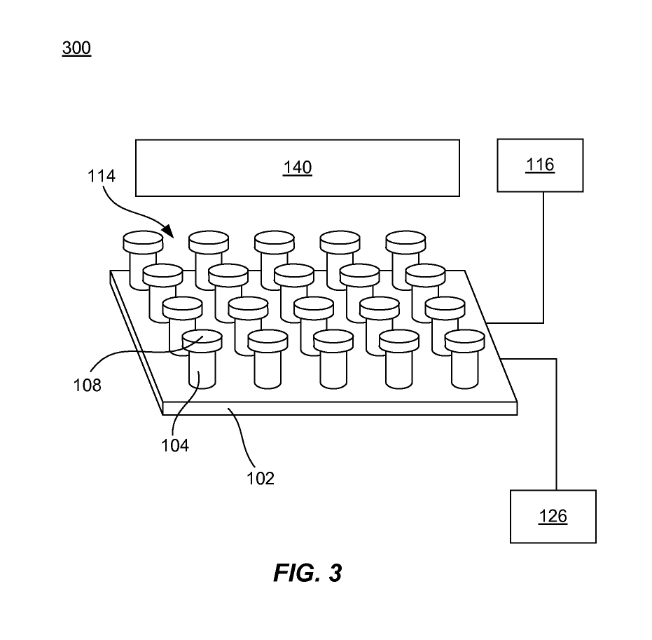

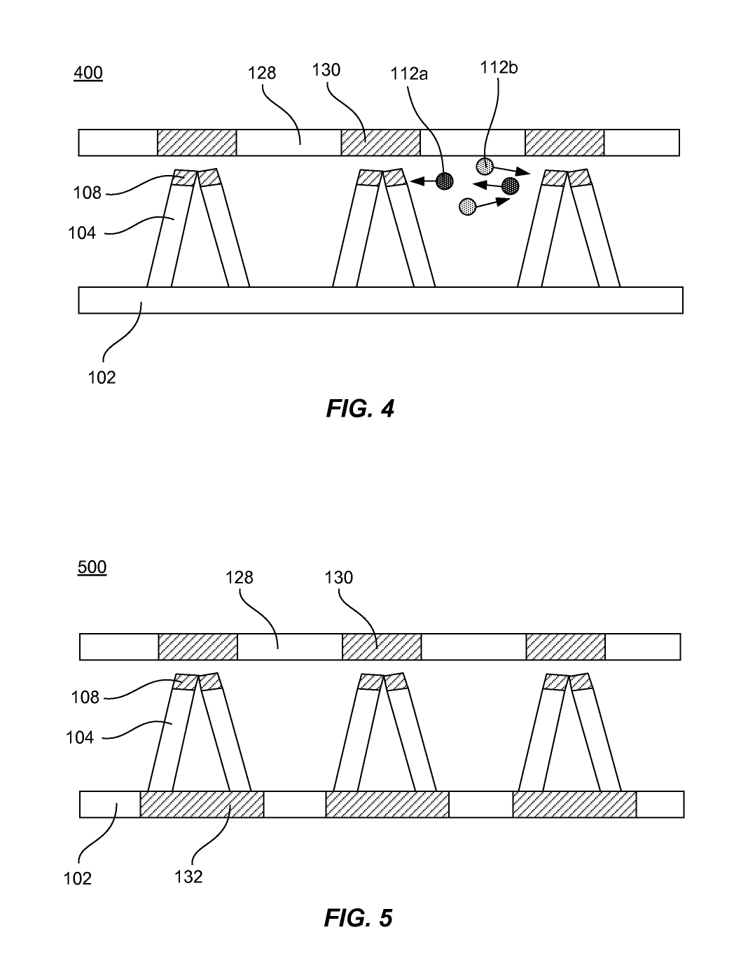

Referring to FIG. 3, a traveling wave dielectrophoresis device 300 is shown more generally as a three dimensional array. The array can include a substrate 102 having an elongated nanostructures 104 attached thereto. The elongated nanostructures can be in the form of a columnar structure with metallic caps 108 deposited thereon. The plurality of nanostructures can form an array 114, and within that array, various sub-arrays can be present or usable. The traveling wave dielectrophoresis device can further include a detector 116 operatively coupled to the nanostructures to detect analytes present in hot spots. In addition to the detector, a controller 126 can be included that is used to apply alternating and out of phase potentials to a plurality of conductive elements (not shown in this example, but shown in FIGS. 4-7) to form traveling wave dielectrophoretic lateral or other forces within the array. Though the controller and the detector are shown as attached to the substrate, it is understood that either can be connected elsewhere as may be useful to carry out their respective functions. For example, in many examples, the controller may actually be connected to an overlay (not shown in this FIG., but shown in FIGS. 4-7) which includes conductive elements in close proximity to the metallic caps. Additionally, a source of excitation energy 140, such as a light source or a laser source, is also shown and can be used to excite the hot spots.

Turning now to FIG. 4, a traveling wave dielectrophoresis device 400 can include a substrate 102 having an elongated nanostructure 104 attached thereto including a columnar structure with a metallic cap 108 deposited thereon. An overlay 128 with conductive elements 130 is also present that is in close proximity to the nanostructures, but in this example, is not in physical contact thereof. Applying alternating biases with appropriate frequencies and phase to the conductive elements (such as conducting strips) as well as to the (conducting) substrate can drive analytes 112a, 112b with different Clausius-Mossotti factors in different directions through a combination of dielectrophoretic and/or electrophoretic forces. Different particles/analytes can be separated and driven to hot spots in SERS structures for Raman analysis. Large field gradients near hot spots can assist in pulling desired analytes to them. Note that in the example shown, groups of posts or elongated nanostructures may be “pre-closed” (as shown) via capillary forces (by applying fluid and letting it dry). Other structured SERS-active surfaces may likewise be employed, as would be appreciated by one skilled in the art after considering the present disclosure.

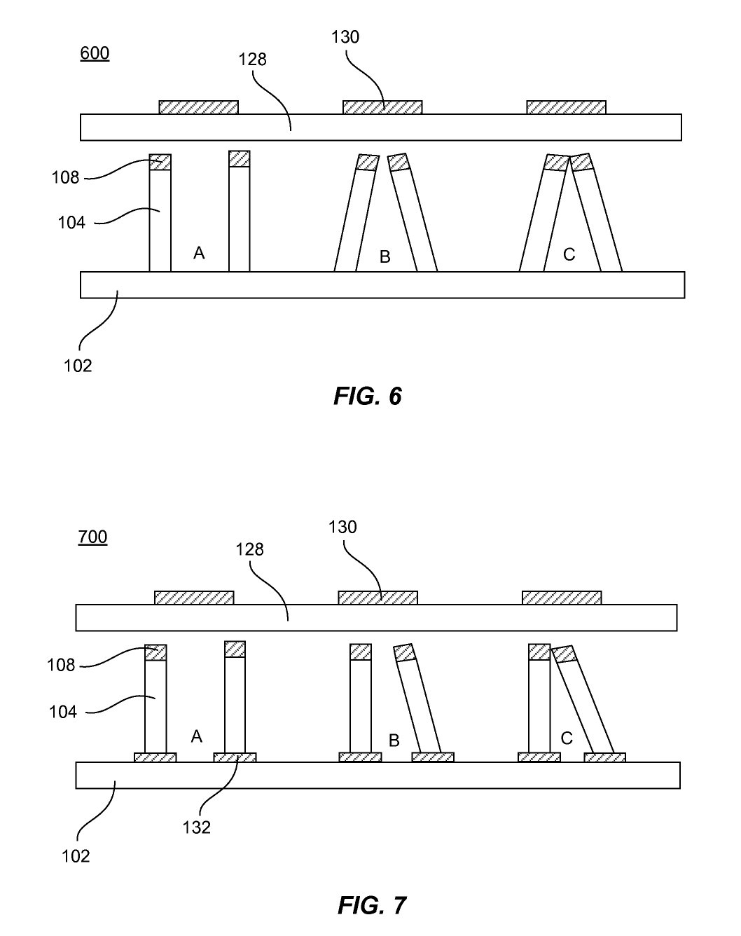

FIG. 5 depicts similar structures as shown in FIG. 4, i.e. a substrate, elongated nanostructures 104, metallic caps 108, overlay 128, conductive elements 130, analytes or other types of particles 112a, 112b, etc. However, in this example the substrate also includes conductive elements 132, such as conducting strips. The conductive elements do not necessarily need to be aligned with elongated nanostructures or posts (which of themselves may or may not be conducting at the columnar structure). With this and other arrangements, there are several possible advantages. For example, independent control of the motion of multiple species in a solution or other fluid can be effectuated, and/or analytes can be sorted (or filtered) and delivered to desired locations for analysis. This system and other similar systems can also provide the ability to deliver analytes directly to Raman hot spots or remove them from hot spots to refresh the sensor surface. In some cases, this is aided by the ability to affect the electrical biases applied directly to the plasmonic structures on the ends of the posts. Still further, the system can provide the ability to actuate Raman hot spots, e.g. by controlling the gaps between particles on posts or by driving plasmonic particles (potentially with analyte attached) toward or away from fixed plasmonic structures (as described briefly hereinafter in FIGS. 6 and 7 as well as previously in FIG. 2, respectively), both of which can aid in making the system reusable.

FIG. 6 depicts similar structures as shown in FIG. 4, i.e. a substrate, elongated nanostructures 104, metallic caps 108, overlay 128, conductive elements 130, etc. However, in this FIG., depicted is a staged series of nanostructures over time A, B, C showing how dielectrophoretic forces may be used to control the gap between particles on adjacent nanostructures or posts. By applying dielectrophoretic forces to the array, gaps between adjacent nanostructures can be closed (from A to C) or opened (from C to A). When opening gaps between adjacent nanostructures, opening is possible provided the metallic caps are not in physical contact, thereby shorting the circuit. If they are not in actual contact, they can be readily opened. In certain examples, a thin dielectric coating or other system can be used to prevent contact between the metal caps so that they can be opened. Of course, in this example, the columnar structure of the nanostructure is typically flexible so that bending between posts can occur. Flexibility can be generated by both material and configuration choice. For example, forming flexible posts can be carried out by using an appropriate polymer or inorganic material that is thin enough that flexibility under dielectrophoretic forces is possible.

FIG. 7 depicts similar structures as shown in FIG. 4, i.e. a substrate, elongated nanostructures 104, metallic caps 108, overlay 128, conductive elements 130, 132, etc. However, in this FIG., depicted is a staged series of nanostructures over time A, B, C showing how dielectrophoretic forces may be used to control the gap between particles on adjacent nanostructures or posts. In this example, one post is rigid and the adjacent post is flexible. Again, by applying dielectrophoretic forces to the array, gaps between adjacent nanostructures can be closed (from A to C) or opened (from C to A). Again, when opening gaps between adjacent nanostructures, opening this is possible provided the metallic caps are not in physical contact. In this example, elongated nanostructures or posts can be asymmetric in terms of their flexibility so that if a force is applied in the same direction to the plasmonic particles and structures, i.e. the direction that drives the flexible structure toward the more rigid structure, the gap between the structures will decrease. Applying a force in the opposite direction increases the gaps.

The substrate and/or the overlay in many of the examples shown herein (as well as their electrodes) can be made transparent to facilitate Raman measurements in some examples. Likewise, though both a substrate and an overlay are shown, the overlay is not always necessarily present. For example, if appropriate electrodes are incorporated on the substrate supporting the SERS-active surface, then the overlay may be omitted in some examples (as shown in FIG. 1).

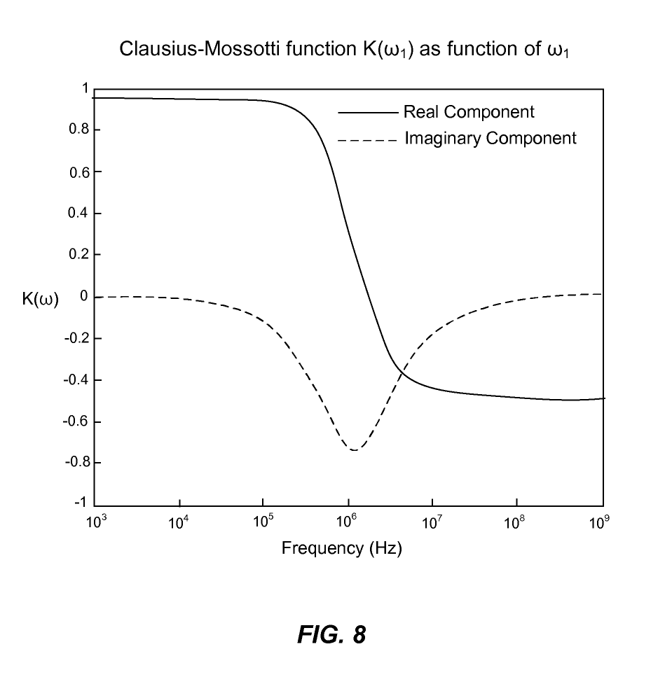

To explain in further detail how Clausius-Mossotti factors can be used to move mobile engineered particles, analytes, electromagnetic field enhancing nanostructures attached to flexible elongated nanostructures, etc., the following provides a brief explanation of these forces. When a particle is exposed to an electric field, its response can be described by K(ω), the Clausius-Mossotti factor, an example of which is shown in FIG. 8. It is a function of the frequency of the driving electric field and the particle's material properties. Consider a particle of radius r with complex permittivity ∈π* suspended in a medium with complex permittivity ∈μ*. When exposed to an electric field E of frequency ω, the DEP force exerted on the particle is:

F_{DEP}=2πr³∈ₘ∇|\vec{E}|²·K( ω̅)

\vec{E}=Re{\vec{E}(\vec{x})·e^{i\vec{φ}(\vec{x})}e^{i ω̅t}}

Note that a complex electric potential φ is used to denote the phase distribution in space. The time-averaged DEP force can be expressed as:

[symbol]

F_{DEP} [symbol] =F_{dcDEP}+F_{twDEP}

F_{dcDEP}=2πr³∈ₘ∇|\vec{E}|²·Re{K( ω̅)}

F_{twDEP}=2πr³∈ₘ(\vec{E}\vec{E}·I)·(∇\vec{φ})·Im{K( ω̅)}

Note also that φ is the phase angle vector to denote the phase distribution in space. F_{dcDEP} denotes the forces originating from non-uniformity of the E-field. This is primarily a translational force, proportional to the real component of the Clausius-Mossotti factor K(ω). When Re{K(ω)}>0 (positive dielectrophoresis, or pDEP), this force drives particles to follow the convergence of the E-field (usually towards the electrodes); when Re{K(ω)}<0 (negative dielectrophoresis, or nDEP), the effect reverses. Control of particle migration can be achieved via adjusting the driving frequency ω and thus Re{K(ω)}. Furthermore, particles can be engineered so that Re{K(ω)} (the solid curve in FIG. 8) acquires desired profiles such that different particles behave differently under the same driving electric field. F_{tWDEP} acts in parallel to the electrode plane. F_{tWDEP} is not only affected by the E-field so that the E-field strength can be a “tuning knob” as with F_{dcDEP}, but is also affected by the gradient of the phase angle φ denoting the travelling electric field (spatial phase shift). This provides an additional design parameter for the electrode configuration and control. Unlike F_{dcDEP}, F_{twDEP} is proportional to the imaginary component of the Clausius-Mossotti factor K(ω), Im{K(ω)}, rather than the real component Re{K(ω)}.

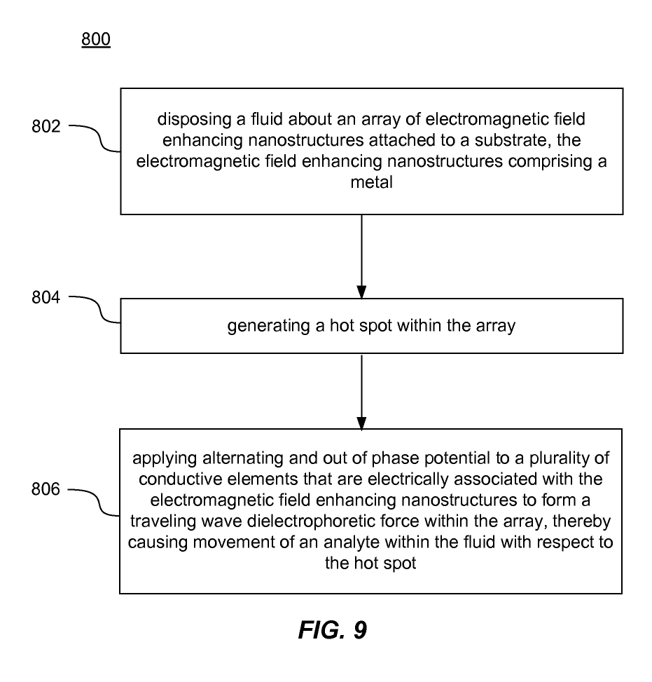

Referring now to FIG. 9, a method 800 of moving analytes can include disposing 802 a fluid about an array of electromagnetic field enhancing nanostructures attached to a substrate, the electromagnetic field enhancing nanostructures including a metal; generating 804 a hot spot within the array; and applying 806 alternating and out of phase potential to a plurality of conductive elements that are electrically associated with the electromagnetic field enhancing nanostructures to form a traveling wave dielectrophoretic force within the array, thereby causing movement of an analyte within the fluid with respect to the hot spot. In one example, the analyte has Clausius-Mossotti (CM) factors suitable for movement of the analyte toward the hot spot. In another example, the analyte has Clausius-Mossotti (CM) factors suitable for movement of the analyte away from the hot spot. In still another example, the analyte does not have Clausius-Mossotti (CM) factors suitable for movement of the analytes with respect to the hot spot, and the method further includes a step of chemically associating the analyte with a mobile engineered particle with an affinity for the analyte, wherein the mobile engineered particle exhibits Clausius-Mossotti (CM) factors suitable for movement of the mobile engineered particle with respect to the hot spot. Note that in any of these scenarios, an analyte magnitude, i.e. the twDEP can be non-zero. Furthermore, when referring to application of dielectrophoretic lateral forces, it is understood that other forces can like but also be applied or used, such as DEP vertical forces and/or EP forces in conjunction in conjunction with DEP lateral forces.

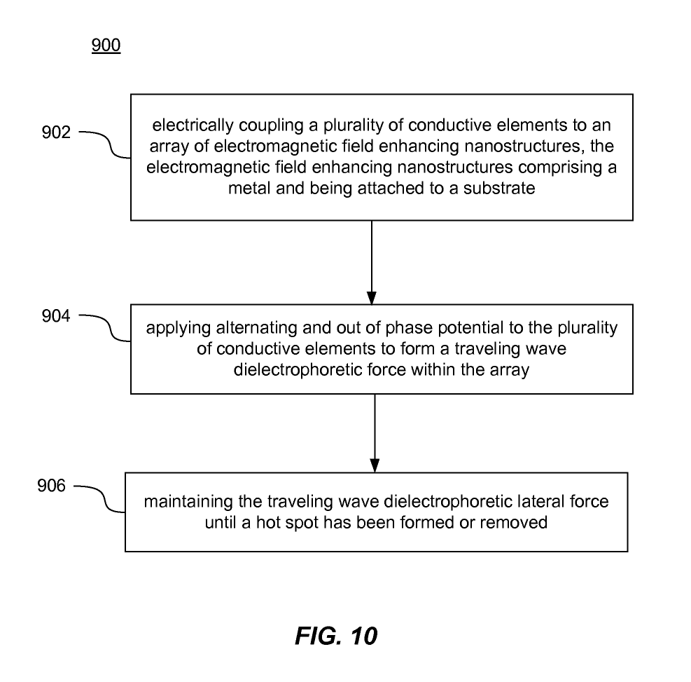

Referring now to FIG. 10, a method 900 of modulating hot spots within a surface-enhanced Raman spectroscopy array, by itself, does feel a DEP force but not in the desired direction or with a desired device can include multiple steps. One step includes electrically coupling 902 a plurality of conductive elements to an array of electromagnetic field enhancing nanostructures, the electromagnetic field enhancing nanostructures including a metal and being attached to a substrate. Additional steps include applying 904 alternating and out of phase potential to the plurality of conductive elements to form a traveling wave dielectrophoretic force within the array; and maintaining 906 the traveling wave dielectrophoretic lateral force until a hot spot has been formed or removed. In this example, when the hot spot is formed, it can be formed by movement of a mobile engineered particle to one or more of the electromagnetic field enhancing nanostructures. It can alternatively be formed by movement of the electromagnetic field enhancing nanostructures together via a least one flexible elongated nanostructure used to attach at least one of the electromagnetic field enhancing nanostructures to the substrate. In another example when the hot spot is removed, it can be removed by movement of a mobile engineered particle away from one or more of the electromagnetic field enhancing nanostructures. Alternatively, it can be removed by movement of the electromagnetic field enhancing nanostructures apart via a least one flexible elongated nanostructure used to attach at least one of the electromagnetic field enhancing nanostructures to the substrate.

It is noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

While the disclosure has been described with reference to certain examples, those skilled in the art will appreciate that various modifications, changes, omissions, and substitutions can be made without departing from the spirit of the disclosure. It is intended, therefore, that the present description be limited only by the scope of the following claims.

What is claimed is:

1. A traveling wave dielectrophoresis sensing device, comprising:
a substrate; and
an array of electromagnetic field enhancing nanostructures attached to the substrate, the electromagnetic field enhancing nanostructures comprising a metal;
a plurality of conductive element electrically associated with the electromagnetic field enhancing nanostructures; and
a controller for applying alternating and out of phase potential to the plurality of conductive elements to form traveling wave dielectrophoretic forces within the array.

2. The traveling wave dielectrophoresis sensing device of claim 1, wherein the controller is adapted to create the traveling wave dielectrophoretic force for generating a hot spot within the array.

3. The traveling wave dielectrophoresis sensing device of claim 2, the device further comprising a mobile engineered particle within the array, the mobile engineered particle including a metal.

4. The traveling wave dielectrophoresis sensing device of claim 3, wherein the hot spot is generated by movement of the mobile engineered particle toward one or more of the electromagnetic field enhancing nanostructures.

5. The traveling wave dielectrophoresis sensing device of claim 3, wherein the mobile engineered particle is modified with a surface active ligand that is formulated to attract an analyte, and wherein i) the mobile engineered particle is adapted to carry the analyte toward the hot spot, or ii) the mobile engineered particle is adapted to carry the analyte therewith as the mobile engineered particle contributes to formation of a hot spot.

6. The traveling wave dielectrophoresis sensing device of claim 1, wherein the electromagnetic field enhancing nanostructures are attached to the substrate through elongated nanostructures having attachment ends and a free ends opposite the attachment ends, the attachment ends affixed to the substrate and the free ends comprising the electromagnetic field enhancing nanostructures.

7. The traveling wave dielectrophoresis sensing device of the claim 6, wherein the hot spot is generated by movement of one or both of two adjacent elongated nanostructures toward one another.

8. The traveling wave dielectrophoresis sensing device of claim 1, wherein the controller is adapted to create the traveling wave dielectrophoretic lateral force for movement of an analyte toward a hot spot.

9. A method of moving analytes, comprising:
disposing a fluid about an array of electromagnetic field enhancing nanostructures attached to a substrate, the electromagnetic field enhancing nanostructures comprising a metal;
generating a hot spot within the array; and
applying alternating and out of phase potential to a plurality of conductive elements that are electrically associated with the electromagnetic field enhancing nanostructures to form a traveling wave dielectrophoretic force within the array, thereby causing movement of an analyte within the fluid with respect to the hot spot.

10. The method of claim 9, wherein the analyte has Clausius-Mossotti factors suitable for movement of the analyte toward the hot spot.

11. The method of claim 9, wherein the analyte has Clausius-Mossotti factors suitable for movement of the analyte away from the hot spot.

12. The method of claim 9, wherein the analyte does not have Clausius-Mossotti factors suitable for movement of the analytes with respect to the hot spot, and the method further comprises a step of chemically associating the analyte with a mobile engineered particle with an affinity for the analyte, wherein the mobile engineered particle exhibits Clausius-Mossotti factors suitable for movement of the mobile engineered particle with respect to the hot spot.

13. A method of modulating hot spots within a surface-enhanced Raman spectroscopy array device, comprising:
electrically coupling a plurality of conductive elements to an array of electromagnetic field enhancing nanostructures, the electromagnetic field enhancing nanostructures comprising a metal and being attached to a substrate;
applying alternating and out of phase potential to the plurality of conductive elements to form a traveling wave dielectrophoretic force within the array; and
maintaining the traveling wave dielectrophoretic lateral force until a hot spot has been formed or removed.

14. The method of claim 13, wherein the hot spot is formed by i) movement of a mobile engineered particle to one or more of the electromagnetic field enhancing nanostructures, or ii) movement of the electromagnetic field enhancing nanostructures together via a least one flexible elongated nanostructure used to attach at least one of the electromagnetic field enhancing nanostructures to the substrate.

15. The method of claim 13, wherein the hot spot is removed by i) movement of a mobile engineered particle away from one or more of the electromagnetic field enhancing nanostructures, or ii) movement of the electromagnetic field enhancing nanostructures apart via a least one flexible elongated nanostructure used to attach at least one of the electromagnetic field enhancing nanostructures to the substrate.
